(19) United States
(12) Patent Application Publication
(10) Pub. No.: US 2013/0014033 A1
(43) Pub. Date: Jan. 10, 2013

(54) SYSTEMS AND METHODS FOR FACILITATING USER INTERACTION BETWEEN MULTIPLE VIRTUAL ENVIRONMENTS

(75) Inventors: Timothy John Hamick, Dallas, TX (US); Nicholas John Mitham, Cambridge (GB); Matthew Peter Warneford, Leeds (GB); Sean Rodger Thompson, Leeds (GB); Kelly Wade Loter, Dallas, TX (US)

(73) Assignee: WoGo LLC, Dallas, TX (US)

(21) Appl. No.: 13/179,358

(22) Filed: Jul. 8, 2011

(51) Int. Cl. G06F 3/048

(52) U.S. Cl. 715/757

(57) ABSTRACT

An interaction system for facilitating user interaction between users using different virtual environments may generate a user interaction interface for the first user. The user interaction interface may present status information regarding a second user currently participating in a second virtual environment to the first user, while the first user may be participating in a first environment that is different from the second environment. The user interaction interface may facilitate real time or near real time interaction between the first user and the second user.

### FIELD OF THE DISCLOSURE

The invention relates to facilitating interaction between users of virtual environments while such users are actively participating in different virtual environments hosted and/or administered by separate entities.

### BACKGROUND

Virtual environments, including virtual spaces, virtual worlds, electronic (online) games, and interactive electronic social media, may be known.

Users of these virtual environments may use separate user accounts in multiple virtual environments. For example, a user may use separate accounts for LinkedIn®, Facebook™, World of Warcraft®, Club Penguin®, Call of Duty®, and/or other virtual environments. A user may use multiple user accounts for multiple virtual environments that may be titles of different games under the same franchise and/or released by the same company (e.g. Activision®), e.g. Call of Duty®: Black Ops, Call of Duty®: Elite, Call of Duty®: Modern Warfare 3, etc. A user may use multiple user accounts for the same virtual environment, e.g. to play a game using different characters and/or to play a game on different platforms. A user may have one user account for multiple virtual environments.

Systems configured to facilitate interaction between users of a virtual environment may be known. A known exemplary implementation may be a chat function in a virtual environment, offering to facilitate a real time or near real time interaction between multiple users of the virtual environment. For example, users of Facebook™ may have access to a chat function that offers to facilitate interaction and/or communication with a user's connections (called “Friends” in this environments), provided at least that a Friend may be currently online and logged in. Other provisions and settings may apply, e.g. a user may indicate he/she may not be available for a chat through this environment in a variety of ways.

Users of virtual environments may have established relationships and/or connections with other users of virtual environments, regardless of whether related and/or connected users have any virtual environments in common. This collection of related and/or connected users may be referred to as the social graph of a user. A user of virtual environments may wish to interact and/or communicate with one or more members of the user's social graph at a particular moment in time. Such a user may be required to exhaustively search through each virtual environment, e.g. by logging in to such a virtual environment and manually verifying availability. Moreover, such a user may not have access to a particular virtual environment that a member of the user's social graph may be currently actively participating in. This is one effect of the “walled garden” phenomenon in virtual environments.

### SUMMARY

One aspect of the disclosure relates to systems and methods of facilitating user interaction and/or communication among users between multiple virtual environments. Such a system may be referred to as an interaction system. The interaction system may generate an interface for presentation to users while the users are participating in different virtual environments. This interface may facilitate interaction and/or communication between users of different virtual environments. The interface may present status information of users to each other regarding the current participation of users in different virtual environments. An interface generated by the interaction system may be presented to a user separately from the presentation of a virtual environment to that user. The interface generated separately form the presentation of the virtual environment may be presented along with the virtual environment such that the interface may seem like an integral part of the virtual environment.

The interaction system may be implemented through one or more interaction servers. The interaction server may be accessible to users via, e.g., individual client computing platforms in a client/server configuration. The interaction server may be separate and discrete (e.g., in hardware and/or software) from the environment servers that host the virtual environments to the client computing platforms. The interaction server may be maintained, administered, and/or controlled by an entity that is separate from the entities that maintain, administer, and/or control virtual environment servers. The interaction server may provide a communication bridge between the walled gardens of the separate virtual environments. Constituent components of the one or more interaction servers may manage access to account information, generate interfaces to facilitate communication between users using different virtual environments, and transmit communications that cause the generated interfaces to be presented to the users, through execution of one or more of a user access module, a user account module, a relationship module, an interface module, a launch module, a status module, and/or other modules. The appearance, interface, functionality, and/or other features of the interaction system may be customized to individual users and/or virtual environments.

The user account module may manage user accounts for multiple users of the interaction system. Such user accounts may include information regarding a plurality of virtual environment accounts. For example, a first user account for a first user of the interaction system may include account identifiers, such as user names, for a Facebook™ account and a World of Warcraft® account. In some implementations, the first user account may include access authorization information associated with the account identifiers. Access authorization information may include one or more of an access code, password, biometric information, a security token, proximity information, an RF token, and/or other ways to supply information that may be used to authorize access to a system in an attempt to keep that system secure.

The user account module may manage storage for and/or access to account information and/or a user profile of users of the interaction system. Account information for the first user of the interaction system may be included within a user profile associated with the first user. Account information may include information identifying a user (e.g. a name, a username or handle, a number, an identifier, and/or other identifying information), a plurality of virtual environment account identifiers for a plurality of virtual environment accounts associated with the first user in different virtual environments, user information, subscription information, virtual currency account information (e.g., related to currency held in credit for the first user), relationship information (e.g., information related to relationships between users in one or more virtual environments and/or information related to the social graph of the first user), usage information, demographic information, settings, preferences, customizations, and/or other account information. Account information may be organized within the user account module on a per-user basis.

For example, a first user account may correspond to a first user of the interaction system, who may be associated with a particular virtual environment that operates externally to the interaction system. A second user of the interaction system may be indicated in the account information of the first user account as having a relationship with the first user (e.g., a friendship). The second user may be associated with a second user account that corresponds to the second user. In this example, the second user account may include an account identifier for a virtual environment account in a virtual environment that may be different than the virtual environment associated with the first user. The interaction system may be configured to facilitate real time or near real time interaction between the first user, whilst the first user may be actively participating in his/her virtual environment, and the second user, whilst the second user may be actively participating in a different virtual environment than the first user's virtual environment.

It will be appreciated that specific descriptions of structure and function with respect to the first and second users and/or user accounts (and/or any other specifically described users and/or user accounts) are for exemplary purposes only, and are not intended to be limiting. The structure and function described with respect to first and second users may extend to any number of individual users of the interaction system.

The interface module may generate user interaction interfaces, which may be configured to facilitate communication between a user and one or more members of the user's social graph. Such communication may include real time or near real time interaction such as, e.g., instant messaging, chat, text messaging, multi-media messaging, voice-over-IP calling, video calling, and/or other real time or near real time interaction and/or communication, or any combination thereof.

The interface module may present, e.g. through a user interaction interface, status information regarding users of multiple virtual environments, and/or may provide other interactive functionality between users. Status information may be supplied by the status module. For example, status information presented to a first user may regard other users of interaction system and/or one or more virtual environments that have some established relationship to the first user, such as being part of the first user's social graph. Status information of a user may include one or more of an indication whether the user may be currently participating in a virtual environment, an indication whether the user may be online, an indication whether the user may be available for real time or near real time interaction, particularly regarding interaction through the user interaction interface, a current position and/or location of the user (e.g. within a particular virtual environment), recent achievements and/or accomplishments, recently posted messages, current virtual health (e.g. within a game), current score, current task/quest/mission/assignment, current level, current opponent/competitor/enemy, and/or other status information of a user. Status information of a user may include a preferred means of interaction for the user. Status information of a user may incorporate a component of timeliness, since up-to-date/current/new information may be more interesting and/or important than old or stale information.

For example, a first user who may be currently participating in SecondLife® may be presented, via the first user's user interaction interface, with status information indicating that one particular member of the first user's social graph, the second user, may be currently available for interaction by virtue of active participation by the second user in Xbox® Live, while another member of the first user's social graph, the third user, may be currently available for interaction by virtue of active participation in PlayStation® Network.

As mentioned above, the user interaction interfaces generated by the interface module may be configured to facilitate communication between users, for presentation to users of the interaction system. The communication may be accomplished across virtual environments. As such, the user interaction interface presented to the first user may facilitate communication between the first user and the second user while the first user is interacting with a first virtual environment and the second user is interacting with a second virtual environment that is different from the first virtual environment Such communication may include one or more of the following (alone or in any combination): real time (or near real time) communication, synchronous communication, asynchronous communication, public, private, and/or semi-private communication, text-based communication, audio-based communication, computer-graphics-based communication, video-based communication, and/or other communication between users. The users may be included in each other's social graph.

Presentation of a generated user interaction interface to a user may be caused from within the interaction system, e.g. through the transmission of communication and/or commands. Alternatively, and/or simultaneously, presentation of a generated user interaction interface may be caused outside the interaction system, e.g. through offered features and/or functions that are presented and/or controlled by one or more virtual environment servers and/or client computing platforms.

For example, a user interaction interface may be presented to a user via a browser window capable of displaying web pages. Usually, browser windows include a variety of standard graphical user interface elements (e.g. selectable buttons) that correspond to built-in browser functions (e.g. go forward to the next web page in a list, go back to the previous web page in a list, go to the home page, etc.), and/or other standard browser interface elements. In some implementations, the window used to present the user interaction interface may lack presentation of native navigation controls for manual navigating of a network and/or may lack presentation of graphical user interface elements that correspond to built-in browser functions. In some implementations, presentation of a user interaction interface may be performed in combination with the presentation of the user environment interface, e.g. in the same window, such as a browser window. For example, the combination may be configured such that the user interaction interface has an appearance as a toolbar in the user environment interface. In some implementations, the combination may be configured such that the user interaction interface may be presented as a browser plug-in. The presentation of a user interaction interface may appear to be integrated with the presentation of the user environment interface, though both interfaces may be controlled separately.

The interface module may be configured to generate a user interaction interface for a first user responsive to one or more determinations. The determinations may include one or more of a determination that the first user may be participating in a virtual environment, a determination that the first user may be participating through a virtual environment account corresponding to an account identifier included in the account information of the first user, a determination that the first user authorized transmission of communications to one or more virtual environment servers and/or client computing platforms such that the communications cause the presentation of views from an instance of a virtual environment to the first user, a determination that a second user may be a member of the first user's social graph, a determination that the second user is associated with a second user account for the interaction system, a determination that the second user may be participating in a different virtual environment than the first user, a determination that the second user may be participating in a virtual environment through a virtual environment account corresponding to an account identifier included in the second user account, a determination that the second user authorized transmission of communications to one or more virtual environment servers and/or client computing platforms such that the communications cause the presentation of views from an instance of a virtual environment to the second user, and/or other determinations.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings and/or examples are for the purpose of illustration and/or description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an interaction system configured to facilitate user interaction between users of different virtual environments.

FIG. 2 illustrates an exemplary embodiment of user interfaces in accordance with one or more implementations.

FIG. 3 illustrates an exemplary embodiment of user interfaces in accordance with one or more implementations.

FIG. 4 illustrates a method for facilitating interactions between users of multiple virtual environments.

### DETAILED DESCRIPTION

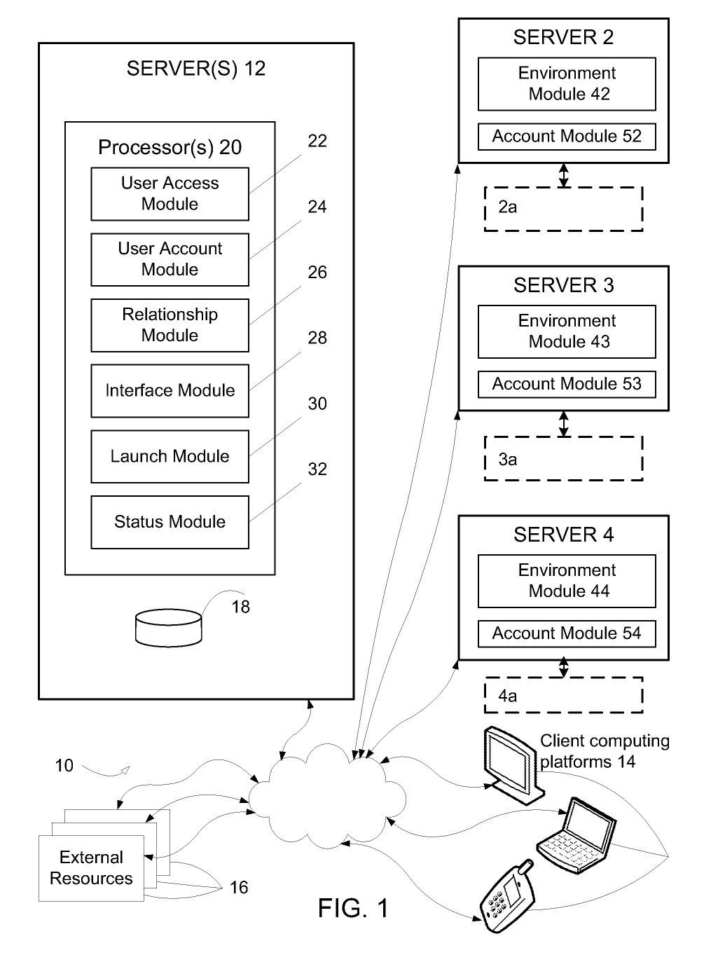

FIG. 1 illustrates an interaction system 10 configured to facilitate user interaction between users of different virtual environments. As used herein, a “virtual environment” may include a virtual space, one or more interactive, electronic social media, and/or other virtual environments. Any virtual environment described herein may use a client/server architecture (e.g. via client computing platforms), and/or any other architecture known for providing virtual environments to users. A virtual environment server may be configured to provide a virtual environment (e.g. via one or more of client computing platforms 14).

Interaction system 10 may cooperate with a plurality of virtual environment servers, e.g. server 2, server 3, server 4, and/or other servers, as shown in FIG. 1. For example, server 2 may be configured to provide virtual environment 2a, server 3 may be configured to provide virtual environment 3a, and server 4 may be configured to provide virtual environment 4a. The scope of the implementations described herein is not intended to be limited by a particular number of virtual environment servers and/or virtual environments. In some implementations, access to interaction system 10 may be integrated into one or more of virtual environments 2a, 3a, and 4a.

Interaction system 10 may include one or more of interaction server(s) 12, external resource(s) 16, client computing platform(s) 14, and/or other components. Interaction server(s) 12 may be configured to communicate with one or more client computing platforms 14 according to a client/server architecture to provide interaction system 10 to users via one or more client computing platforms 14. Client computing platforms 14 may provide access to the virtual environments hosted by virtual environment servers 2, 3, and/or 4.

Interaction server 12 may be configured to execute one or more computer program modules. The one or more computer program modules may include one or more of a user access module 22, a user account module 24, a relationship module 26, an interface module 28, a launch module 30, a status module 32, and/or other modules.

User access module 22 may be configured to manage user access to interaction system 10. Access to interaction system 10 may be granted pursuant to setup of a user account for interaction system 10. Access to interaction system 10 may require one or more of a user account, a user name and/or user identifier, security login information (e.g. an access code and/or password), and/or other information. Other functionalities attributed herein to modules of interaction server(s) 12 may be unavailable to a user until access to interaction system 10 has been authorized, e.g. through user access module 22. User access module 22 may be configured to generate a user interface for presentation to users through which entry and/or selection of the required authentication information may be received. The user interface may be presented to the users, for example, through client computing platforms 14.

User access module 22 may be configured to manage user access to a virtual environment, e.g., virtual environments 2a, 3a, and/or 4a. Access to a virtual environment may require one or more of a virtual environment user account, a user name and/or user identifier, security login information (e.g. an access code and/or password), and/or other information. User access module 22 may thus be used to authorize access to a virtual environment. User access module 22 may be configured to generate a user interface for presentation to users through which entry and/or selection of the required authentication information for the virtual environment may be received. The user interface may be presented to the users, for example, through client computing platforms 14. User access module 22 may be configured to store the required authentication information for the virtual environment for future usage. For example, a user may, during a subsequent usage of interaction system 10, be automatically authorized for the virtual environment and/or presented with an option to be authorized for the virtual environment through the interaction system 10, without requiring entry and/or selection of the authentication information for the virtual environment.

User account module 24 may be configured to manage (storage for and/or access to) account information and/or a user profile of a user. Account information and/or a user profile may include information stored by server 12, information stored by one or more client computing platforms 14, information stored by one or more of servers 2, 3, and 4, and/or other storage locations. Account information for a specific user may be included within a user profile associated with the specific user.

Account information may include information identifying a user (e.g. a name, a username or handle, a number, an identifier, and/or other identifying information), a plurality of virtual environment account identifiers for a plurality of virtual environment accounts associated with a user in different virtual environments, user information, subscription information, virtual currency account information (e.g., related to currency held in credit for a user), relationship information (e.g., information related to relationships between users in one or more virtual environments and/or information related to the social graph of a user), usage information, demographic information, settings, preferences, customizations, information related to past interactions, achievements, evaluations, and/or purchases pertaining to a user, information derived by analysis, provided information of a user, stated information, account history of a user, browsing history of a user, a client computing platform identification associated with a user, a phone number associated with a user, and/or other account information. Account information may be organized within the user account module on a per-user basis (e.g., into user accounts corresponding to the individual users).

A virtual environment account identifier may include information that identifies a user and/or a character associated with the user in a corresponding virtual environment. or example, a virtual environment account identifier may include one or more a user name, an account number, an avatar or character name, and/or other identifying information.

A first user account may correspond to a first user of the interaction system, who may be associated with a particular virtual environment, e.g. virtual environment 2a, that operates externally to the interaction system. A second user of the interaction system may be indicated in the account information of the first user account as having a relationship with the first user (e.g., a friendship). The second user may be associated with a second user account that corresponds to the second user. The second user account may include an account identifier for a virtual environment account in a virtual environment that may be different than the virtual environment associated with the first user, e.g. virtual environment 3a. Interaction system 10 may be configured to facilitate communication between the first user and the second user while the first user is participating in virtual environment 2a and the second user is concurrently participating in virtual environment 3a.

Status module 32 may be configured to obtain status information. The status information obtained may be implemented, without limitation, by interface module 28 in particular. Status module 32 may be configured to retrieve status information from a virtual environment server, such as server 2, 3, and/or 4. Status module 32 may establish a connection with, e.g., virtual environment server 2, and/or a constituent component of virtual environment server 2. Subsequent to establishing a connection, status module 32 may query virtual environment server 2 for status information. Such a query may be user-specific, e.g. by including a user identifier as part of the query. Alternatively, and/or simultaneously, such a query may be specific to a set of users, for example, users that are part of a particular social graph. The query may pertain all available current status information of a specific user, and/or may be more restricted. In response to the query, status module 32 may receive status information from virtual environment server 2, and optionally process the status information prior to being used for presentation. Different virtual environments may keep track of different types of status information that may be of interest, e.g. to a user of interaction system 10.

Alternatively, and/or simultaneously, status module 32 may be configured to receive status information from a virtual environment server, such as server 2, 3, and/or 4. For example, virtual environment server 3 may establish a connection with status module 32. Subsequent to establishing a connection, virtual environment server 3 may gather, generate, and/or prepare status information that may be specifically intended for status module 32, in particular for the current user associated with status module 32.

Status information of a user may include one or more of an indication whether the user may be currently participating in a virtual environment, an indication whether the user may be online, an indication whether the user may be available for real time or near real time interaction, particularly regarding interaction through the user interaction interface, a current position and/or location of the user (e.g. within a particular virtual environment), recent achievements and/or accomplishments, recently posted messages, current virtual health (e.g. within a game), current score, high score, current or completed task/quest/mission/assignment, current or completed level, current opponent/competitor/enemy, and/or other status information of a user. Status information of a user may include a preferred means of interaction for the user. Status information of a user may incorporate a component of timeliness, since up-to-date/current/new information may be more interesting and/or important than old or stale information.

Interface module 28 may be configured to generate a user interaction interface configured to facilitate communication between users. The user interaction interface may be configured to present status information regarding users of multiple virtual environments (e.g. virtual environments 2a, 3a, and/or 4a). For example, the user interaction interface may present status information to a first user regarding other users of interaction system 10 and/or one or more virtual environments that may have some established relationship to the first user, such as being part of the first user's social graph. In some implementations, communications between users and/or the sharing of status information between users may not require any active and/or current participation in a virtual environment other than interaction system 10. In some implementations, multiple users may share the same chat room (and/or other means of facilitating communication and/or the sharing of information between users) based on a shared similarity and/or commonality within interaction system 10, e.g. based on location and/or position information within a particular virtual environment and/or any other account information and/or status information of one or more users. This functionality may be independent of the available features within the particular virtual environment.

As mentioned above, the user interaction interfaces generated by interface module 28 may be configured to facilitate communication between users, for presentation to users of the interaction system. The communication may be accomplished across virtual environments. Communication may include one or more of the following (alone or in any combination): real time (or near real time) communication, synchronous communication, asynchronous communication, public, private, and/or semi-private communication, text-based communication, audio-based communication, computer-graphics-based communication, video-based communication, and/or other communication between users. The users may be included in each other's social graph.

Presentation of a generated user interaction interface to a user may be caused from within interaction system 10, e.g. through the transmission of communication and/or commands. Alternatively, and/or simultaneously, presentation of a generated user interaction interface may be caused outside interaction system 10, e.g. through offered features and/or functions that are presented and/or controlled by one or more virtual environment servers (e.g. server 2, 3, and/or 4) and/or client computing platforms 14.

Interface module 28 may be configured to generate a user interaction interface for a first user responsive to one or more determinations. The determinations may include one or more of a determination that the first user may be participating in a virtual environment, a determination that the first user may be participating through a virtual environment account corresponding to an account identifier included in the account information of the first user, a determination that the first user authorized transmission of communications to one or more virtual environment servers and/or client computing platforms such that the communications cause the presentation of views from an instance of a virtual environment to the first user, a determination that a second user may be a member of the first user's social graph, a determination that the second user is associated with a second user account for the interaction system, a determination that the second user may be participating in a different virtual environment than the first user, a determination that the second user may be participating in a virtual environment through a virtual environment account corresponding to an account identifier included in the second user account, a determination that the second user authorized transmission of communications to one or more virtual environment servers and/or client computing platforms such that the communications cause the presentation of views from an instance of a virtual environment to the second user, and/or other determinations.

Interface module 28 may generate user interaction interfaces, configured to facilitate communication and the sharing of information between users, for presentation to users of the interaction system. The users may be included in each other's social graph. In some implementations, a user may be presented with an up-to-date stream of information, e.g. akin to a news feed, wherein the information includes status information of other users, account information of other users, and/or other information. The functionality of the interface module may be accomplished through the use of application programming interfaces (APIs) that may be specific to a given virtual environment.

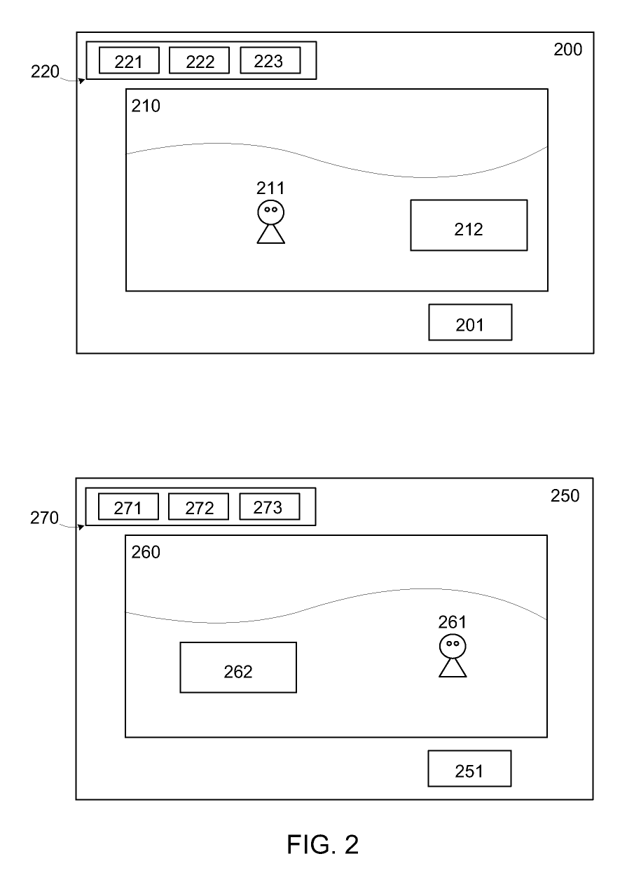

By way of illustration, FIG. 2 illustrates an exemplary embodiment of user interfaces in accordance with one or more implementations. First user interface 200 may be presented to a first user through, e.g., a particular client computing platform 14. Second user interface 250 may be presented to a second user through, e.g., another client computing platform 14. A given virtual environment server, e.g. server 2, may present the first user with first user interface 200. First user interface 200 may include a first user interaction interface 220, one or more native interaction elements 201, an instance of a first virtual environment, and/or other interface elements.

First user interaction interface 220 may include interaction elements 221, 222, and 223. The instance of the first virtual environment, e.g. virtual environment 2a, may be presented to the first user through first user environment interface 210. Elements of first user environment interface 210 may include avatar 211, one or more native interaction elements 212 (which may be specific to the implementation of the virtual environment), and/or other elements. Elements of first user interaction interface 220, first user environment interface 210, and/or first user interface 200 may be implemented as fields configured to receive entry and/or selection from the first user. The fields may include one or more of a text entry field, a set of selectable menu items, a selectable field, and/or other fields configured to receive entry and/or selection from the first user. For example, interaction element 221 may present an identifier associated with a second user of interaction system 10 who may be in the social graph of the first user. For example, interaction element 222 may present an indication regarding status information of the second user, such as an indication that the second user may be available for real time or near real time interaction. For example, interaction element 223 may present a functional element that launches a chat session, for the first user, with the second user, e.g. within first user interaction interface 220.

A given virtual environment server, e.g. server 3, may present the second user with a second user interface 250. Second user interface 250 may include a second user interaction interface 270, one or more native interaction elements 251, an instance of a second virtual environment, and/or other interface elements. Second user interaction interface 270 may include interaction elements 271, 272, and 273. The instance of the second virtual environment, e.g. virtual environment 3a, may be presented to the second user through second user environment interface 260. Elements of second user environment interface 260 may include avatar 261, one or more native interaction elements 262 (which may be specific to the implementation of the virtual environment), and/or other elements.

Elements of second user interaction interface 270, first user environment interface 260, and/or first user interface 250 may be implemented as fields configured to receive entry and/or selection from the second user. For example, interaction element 271 may present an identifier associated with the first user, who may have been presented with first user interface 200, and who may be in the social graph of the second user. For example, interaction element 272 may present an indication regarding status information of the first user, such as an indication that the first user may be available for real time or near real time interaction. For example, interaction element 273 may present a functional element that launches a chat session, for the second user, with the first user, e.g. within second user interaction interface 270. In this example, the first user may chat with the second user through first user interaction interface 220, while the second user may simultaneously chat with the first user through second user interaction interface 270.

First and second user interaction interfaces 220 and 270 may represent an interface to interaction system 10, e.g. through one or more APIs, embedded (HTML) objects, a plug-in, and/or another way to combine separate interfaces for presentation to a user. First and second user interaction interfaces 220 and 270 may be provided by interaction system 10, e.g. by interface module 28 (not shown in FIG. 2).

Referring to FIG. 1, launch module 30 may be configured to transmit communications to virtual environment servers 2, 3, and/or 4 and/or client computing platforms 14, that may be external to interaction server(s) 12, such that the communications cause one or more presentations to be made to a user. Presentations may include one or more of a presentation of a user interaction interface (such as, e.g., generated by interface module 28), a presentation of a user environment interface, wherein the user environment interface includes views from an instance of a virtual environment, and/or other presentations.

Presentation of a user interaction interface, that may be generated by launch module 30, may be performed using a window separate from the presentation of the user environment interface. “Window” may refer to the graphical user interface element used in certain operating systems, such as Windows®, to present separate programs. For example, a user interaction interface may be presented to a user via a browser window capable of displaying web pages. Usually, browser windows include a variety of standard graphical user interface elements (e.g. selectable buttons) that correspond to built-in browser functions (e.g. go forward to the next web page in a list, go back to the previous web page in a list, go to the home page, etc.), and/or other standard browser interface elements. In some implementations, the window used to present the user interaction interface may lack presentation of native navigation controls for manual navigating of a network and/or may lack presentation of graphical user interface elements that correspond to built-in browser functions.

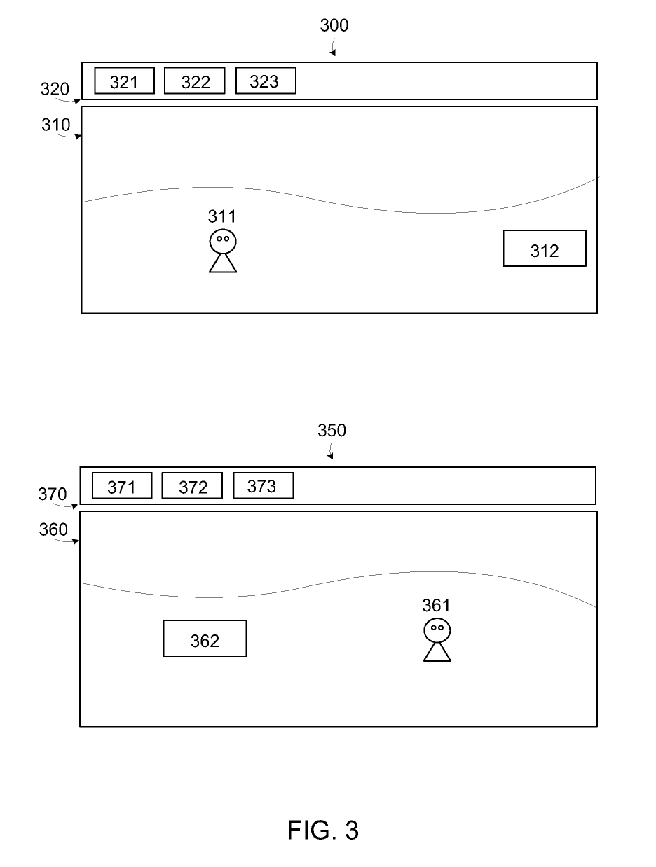

In some implementations, presentation of a user interaction interface may be performed in combination with the presentation of the user environment interface, e.g. in the same window, such as a browser window. For example, the combination may be configured such that the user interaction interface has an appearance as a toolbar in the user environment interface. By way of illustration, FIG. 3 illustrates an exemplary embodiment of user interfaces in accordance with one or more implementations. First user interface 300 may be presented to a first user through, e.g., a particular client computing platform 14. Second user interface 350 may be presented to a second user through, e.g., another client computing platform 14. First user interface 300 may include a first user interaction interface 320, a first user environment interface 310 (e.g. presenting views of an instance of a first virtual environment), and/or other interface elements. A given virtual environment server, e.g. server 2, may present the first user with first user environment interface 310.

First user interaction interface 320 may include interaction elements 321, 322, and 323. An instance of the first virtual environment, e.g. virtual environment 2a, may be presented to the first user through first user environment interface 310. Elements of first user environment interface 310 may include avatar 311, one or more native interaction elements 312 (which may be specific to the implementation of the virtual environment), and/or other elements. Elements of first user interaction interface 320, and/or first user environment interface 310 may be implemented as fields configured to receive entry and/or selection from the first user. The fields may include one or more of a text entry field, a set of selectable menu items, a selectable field, and/or other fields configured to receive entry and/or selection from the first user. For example, interaction element 321 may present an identifier associated with a second user of interaction system 10 who may be in the social graph of the first user. For example, interaction element 322 may present an indication regarding status information of the second user, such as an indication that the second user may be available for real time or near real time interaction. For example, interaction element 323 may present a functional element that launches a chat session, for the first user, with the second user, e.g. within first user interaction interface 320.

A given virtual environment server, e.g. server 3, may present the second user with a second user interface 350, e.g. through a client computing platform 14. Second user interface 350 may include a second user interaction interface 370, a second user environment interface 360 (e.g. presenting views of an instance of a second virtual environment), and/or other interface elements. A given virtual environment server, e.g. server 3, may present the second user with second user environment interface 360.

Second user interaction interface 370 may include interaction elements 371, 372, and 373. An instance of the second virtual environment, e.g. virtual environment 3a, may be presented to the second user through second user environment interface 360. Elements of second user environment interface 360 may include avatar 361, one or more native interaction elements 362 (which may be specific to the implementation of the virtual environment), and/or other elements. Elements of second user interaction interface 370, and/or second user environment interface 360 may be implemented as fields configured to receive entry and/or selection from the second user. The fields may include one or more of a text entry field, a set of selectable menu items, a selectable field, and/or other fields configured to receive entry and/or selection from the second user. For example, interaction element 371 may present an identifier associated with a first user of interaction system 10 who may be in the social graph of the second user. For example, interaction element 372 may present an indication regarding status information of the first user, such as an indication that the first user may be available for real time or near real time interaction. For example, interaction element 373 may present a functional element that launches a chat session, for the second user, with the first user, e.g. within second user interaction interface 370. In this example, the first user may chat with the second user through first user interaction interface 320, while the second user may simultaneously chat with the first user through second user interaction interface 370. In some implementations, presentation of a user interaction interface may be performed by a combination of windows, such that at least one window is separate from the presentation of the user environment interface, and at least one window is shared in combination with the presentation of the user environment interface.

Referring to FIG. 1, as mentioned before, launch module 30 may be configured to transmit communications to virtual environment servers 2, 3, and/or 4 and/or client computing platforms 14, such that the communications cause one or more presentations to be made to a user. One example of such a presentation may be an instance of virtual environment 2a, 3a, and/or 4a, which may appear, once presented, substantially indistinguishable from the presentation of an instance of virtual environment 2a, 3a, and/or 4a as would have resulted when a user directly accesses virtual environment server 2, 3, and/or 4 without any intervention, interaction, or even existence of interaction system 10. In other words, a user can log in to a virtual environment 2a, 3a, and/or 4a through interaction system 10 (specifically through access authorization by user access module 22). Once virtual environment 2a, 3a, and/or 4a has been “launched” this way, interaction system 10 may present additional interfaces, such as e.g. user interaction interface 220 or user interaction interface 320.

Referring to FIG. 1, relationship module 26 may be configured to establish mutual relationships between users of virtual environments (e.g. virtual environments 2a, 3a, and/or 4a). Such relationships may include one or more of friendships, guilds (with guild-mates), alliances, connections, followers, (temporary) teams, tribes, (temporary) opponents, and/or other relationships. In some implementations, a relationship may be suggested and/or encouraged based on shared similarities and/or commonalities within interaction system 10. Information regarding a user's relationships may be stored, e.g. in the user's account information. Information regarding a user's social graph may be used to establish relationships. Conversely, established relationships may be used to enhance a user's social graph and/or enhance the stored information regarding a user's social graph. Relationship module 26 may establish relationships based on relationship requests and/or acceptances received from users. Establishment of a relationship may be initiated by a single communication (e.g., a request) initiated by a first user requesting a relationship between the first user and one or more other users. Establishment of a relationship may require a first communication from the first user to be approved by the one or more other users. Relationships may include one or more types of relationships that have a functional purpose or impact within a virtual environment, and/or one or more types of relationships that a social construct within the virtual environment that does not have a functional result.

Establishment of a relationship between users of virtual environments may be configured based on an analysis of relationships of a first user with other users in a virtual environment that the first user uses. For example, a first user's account information for a Facebook™ account may be mined and/or analyzed, e.g. by relationship module 26, to establish and/or discover relationships with a second user using Facebook™.

Interaction server(s) 12 may include processor(s) 20, electronic storage 18, and/or other components. Interaction server(s) 12 may include communication lines, or ports to enable the exchange of information with one or more networks (e.g. the Internet) and/or other computing platforms. Processor(s) 20 may be configured to provide information processing capabilities in interaction server(s) 12 through one or more of hardware, software, and/or firmware. Processor(s) 20 may be configured to execute one or more computer program modules.

Though interaction system 10 may be described in certain sections herein as including interaction server(s) 12, this is not intended to be limiting. Interaction server(s) 12, or any component thereof, may be separate and distinct from interaction system 10. In some implementations, one or more functionalities attributed herein to interaction server(s) 12 may be provided by one or more of servers 2, 3, 4, and/or one or more of client computing platforms 14. For example, interaction server(s) 12 may be implemented by a cloud of computing platforms operating together. In some implementations, one or more functionalities attributed herein to one or more of servers 2, 3, 4, and/or one or more of client computing platforms 14 may be provided by (and/or incorporated in) a constituent component of interaction server(s) 12.

Client computing platform(s) 14 may include one or more processors configured to execute computer program modules. The computer program modules may be configured to enable an expert or user associated with a given client computing platform 14 to interact with interaction system 10, and/or external resources 16, and/or provide other functionality attributed herein to client computing platforms 14. By way of non-limiting example, the given client computing platform 14 may include one or more of a desktop computer, a laptop computer, a handheld computer, a NetBook, a Smartphone, a tablet, a gaming console, and/or other computing platforms.

External resources 16 may include sources of information, hosts and/or providers of virtual environments outside of interaction system 10, external entities participating with interaction system 10, external vendors, and/or other resources. In some implementations, some or all of the functionality attributed herein to external resources 16 may be provided by resources included in interaction system 10.

Electronic storage 18 may comprise electronic storage media that electronically stores information. The electronic storage media of electronic storage 18 may include one or both of system storage that may be provided integrally (i.e., substantially non-removable) with interaction server(s) 12 and/or removable storage that may be removably connectable to interaction server(s) 12 via, for example, a port (e.g., a USB port, a firewire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 18 may include one or more virtual storage resources (e.g., cloud storage, a virtual private network, and/or other virtual storage resources). Electronic storage 18 may store software algorithms, information determined by processor(s) 20, information received from interaction server(s) 12, information received from client computing platforms 14, and/or other information that enables interaction server(s) 12 to function as described herein.

Processor(s) 20 may be configured to provide information processing capabilities in interaction server(s) 12. As such, processor(s) 20 may include one or more of a digital processor, an analog processor, a digital circuit designed to process information, an analog circuit designed to process information, a state machine, and/or other mechanisms for electronically processing information. Although processor(s) 20 may be shown in FIG. 1 as a single entity, this is for illustrative purposes only. In some implementations, processor(s) 20 may include a plurality of processing units. These processing units may be physically located within the same device, or processor(s) 20 may represent processing functionality of a plurality of devices operating in coordination. Processor(s) 20 may be configured to execute one or more computer program modules, including user access module 22, user account module 24, relationship module 26, interface module 28, launch module 30, status module 32, and/or other modules. Processor(s) 20 may be configured to execute modules 22, 24, 26, 28, 30, and/or 32 by software; hardware; firmware; some combination of software, hardware, and/or firmware; and/or other mechanisms for configuring processing capabilities on processor(s) 20.

It should be appreciated that although modules 22, 24, 26, 28, 30, and 32 are illustrated in FIG. 1 as being co-located within a single processing unit, in implementations in which processor(s) 20 includes multiple processing units, one or more of modules 22, 24, 26, 28, 30 and/or 32 may be located remotely from the other modules. The description of the functionality provided by the different modules 22, 24, 26, 28, 30, and/or 32 described below is for illustrative purposes, and is not intended to be limiting, as any of modules 22, 24, 26, 28, 30, and/or 32 may provide more or less functionality than is described. For example, one or more of modules 22, 24, 26, 28, 30, and/or 32 may be eliminated, and some or all of its functionality may be provided by other ones of modules 22, 24, 26, 28, 30, and/or 32. As another example, processor(s) 20 may be configured to execute one or more additional modules that may perform some or all of the functionality attributed below to one of modules 22, 24, 26, 28, 30, and/or 32.

Interaction server(s) 12 may communicate with one or more of servers 2, 3, and 4, configured to provide virtual environments 2a, 3a, and 4a, respectively, to facilitate real time or near real time interaction between users of interaction system 10.

Server 2 may be configured to provide virtual environment 2a for one or more users, which may include hosting virtual environment 2a over a network. Similarly, servers 3 and 4 may be configured to provide virtual environments 3a and 4a, respectively. The scope of this disclosure is not limited in any way by the implementation or architecture of virtual environments such as virtual environments 2a, 3a, and 4a. Virtual environments 2a, 3a, and 4a may be similar and/or different in terms of implementation and/or architecture. Virtual environments 2a, 3a, and 4a may provide access to each other. Server 2 may include one or more of an environment module 42, an account module 52, and/or other constituent components. Server 3 may include one or more of an environment module 43, an account module 53, and/or other constituent components. Server 4 may include one or more of an environment module 44, an account module 54, and/or other constituent components.

Environment modules 42, 43, and 44 may be configured to implement instances of the respective virtual environments, which may be executed to determine views of the respective virtual environments. The views may then be communicated (e.g., via streaming, via object/position data, and/or other information) from servers 2, 3, and 4 to client computing platforms 14 for presentation to users. The view determined and transmitted to a given client computing platform 14 may correspond to a user character being controlled by a user via the given client computing platform 14. The view determined and transmitted to a given client computing platform 14 may correspond to a location in a particular virtual environment (e.g., the location from which the view may be taken, the location the view depicts, and/or other locations), a zoom ratio, a dimensionality of objects, a point-of-view, and/or view parameters. One or more of the view parameters may be selectable by the user.

An instance of virtual environments 2a, 3a, or 4a may comprise a simulated space that may be accessible by users via clients (e.g., client computing platforms 14) that present the views of the respective virtual environment to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the simulated space. In some instances, the topography may describe a surface (e.g., a ground surface) that runs through at least a substantial portion of the simulated space. In some instances, the topography may describe a volume with one or more bodies positioned therein (e.g., a simulation of gravity-deprived space with one or more celestial bodies positioned therein). An instance of virtual environments 2a, 3a, or 4a may be synchronous, asynchronous, and/or semi-synchronous.

The above description of the manner in which views of virtual environments 2a, 3a, and 4a are determined by environment modules 42, 43, and 44 is not intended to be limiting. Environment modules 42, 43, and 44 may be configured to express the respective virtual environments (and/or any virtual objects therein) in a more limited, or more rich, manner. For example, views determined for a given virtual environment may be selected from a limited set of graphics depicting an event in a given place within the given virtual environment. The views may include additional content (e.g., text, audio, pre-stored video content, and/or other content) that describes particulars of the current state of the place, beyond the relatively generic graphics. For example, a view may include a generic battle graphic representation with a textual description of the opponents to be confronted. Other expressions of individual places, actions, and/or virtual objects within virtual environments 2a, 3a, and 4a are contemplated.

Within the instance(s) of virtual environments 2a, 3a, and 4a, implemented by environment modules 42, 42, and 44, respectively, users may control characters, (virtual) objects, simulated physical phenomena (e.g., wind, rain, earthquakes, and/or other phenomena), and/or other elements within the respective virtual environments to interact with the virtual environments and/or each other. The user characters may include avatars. As used herein, the term “user character” may refer to an object (or group of objects) present in a virtual environment that represents an individual user. The user character may be controlled by the user with which it may be associated. The user-controlled element(s) may move through and interact with the virtual environment (e.g., non-user characters in the virtual environment, objects in the virtual environment). The user-controlled elements controlled by and/or associated with a given user may be created and/or customized by the given user. The user may have an inventory of virtual goods and/or currency that the user can use (e.g., by manipulation of a user character or other user controlled element, and/or other items) within the virtual environment. A virtual good may be classified as one or more of decorative, functional, access-driven, behavioral, and/or other classifications. A virtual good may include, without limitation, an object with or without abilities, an ingredient, a virtual mineral or ore, a virtual herb, leaf, stem, seeds or root, a protective object, a tool, a weapon, a pet, a vehicle, a mount, a map, clothing, furniture, buildings, floors, wallpaper, documents, music, newspapers, magazines, a digital copy of a video game, other media, artwork and/or other goods or items. A user's status information may be related to the user's virtual inventory, recent purchases, and/or one or more virtual goods. Presentation to a first user of multiple users in the first user's social graph, e.g. through a user interaction interface, may be ranked or ordered using any account information and/or status information, respectively. For example, the multiple users may be grouped per virtual environment, listed alphabetically, ranked by achievements, organized according to perceived strength of the personal bond (e.g. as may be determined by relationship module 26), and/or otherwise ordered within the user interaction interface.

Users may participate in instances of virtual environments 2a, 3a, and/or 4a by controlling one or more of the available user-controlled elements in a given virtual environment. Control may be exercised through control inputs and/or commands input by the users through client computing platforms 14. The users may interact with each other through communications exchanged within a given virtual environment. Such communications may include one or more of textual chat, instant messages, private messages, voice communications, and/or other communications. Communications may be received and entered by the users via their respective client computing platforms 14. Communications may be routed to and from the appropriate users through servers 2, 3, and/or 4 (e.g., through environment modules 42, 43, and/or 44).

In some implementations, one or more of virtual environments 2a, 3a, and/or 4a may include interactive, electronic social media. Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting specific examples of interactive, electronic social media may include the micro-blogging service provided by Twitter™, the social network provided by Facebook™, the social network provided by MySpace™, the social network provided by Foursquare®, the virtual world provided by SecondLife®, the massively multi-player online game provided by World of Warcraft® or Club Penguin®, the social game FarmVille™, the file sharing service provided by Flickr®, Blogger, YouTube, PlayStation® Home, Xbox® Live, and/or other interactive electronic social media.

Account modules 52, 53, and 54 of server 2, 3, and 4, respectively, may be configured to manage (storage for and/or access to) external account information related to a user account for virtual environment 2a, 3a, and 4a, respectively. External account information may include information identifying a user (e.g. a username or handle, a number, an identifier, and/or other identifying information), user information, subscription information, virtual currency account information (e.g., related to currency held in credit for a user), relationship information (e.g., information related to relationships between users in a virtual environment and/or information related to a user's social graph), usage information, demographic information, settings, preferences, customizations, and/or other external account information related to a user account for virtual environment 2a, 3a, and 4a, respectively. External account information of a user may be (made) available to interaction system 10 (e.g. to user account module 24) pursuant to a user of interaction system 10 providing account identifiers corresponding to user account associated with one or more of virtual environments 2a, 3a, and 4a. Usage of external account information may be subject to user authorization.

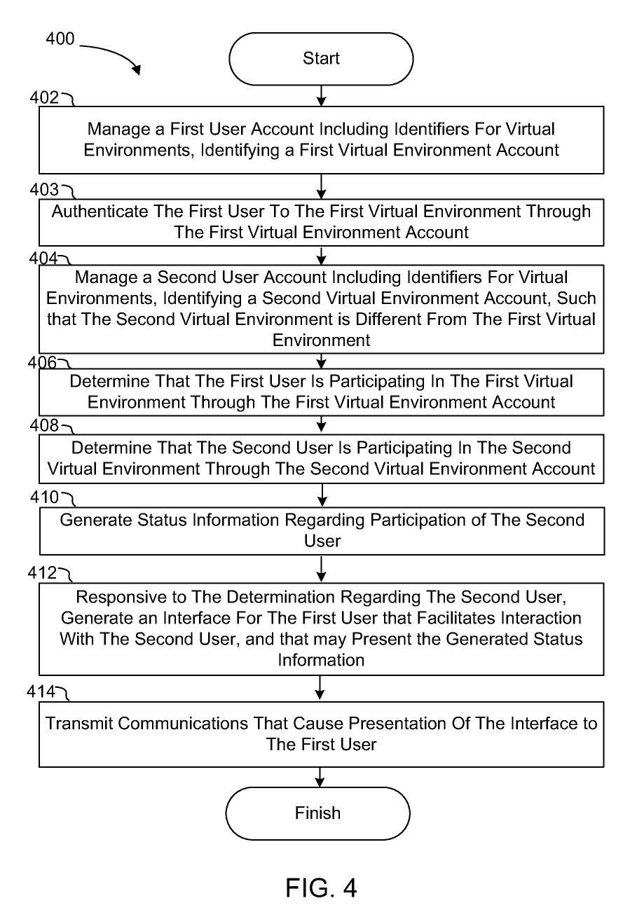

FIG. 4 illustrates a method 400 for facilitating interactions between users of multiple virtual environments. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, a first user account is managed, wherein the first user account includes account identifiers corresponding to user accounts associated with virtual environments. The account identifiers include a first account identifier for a first virtual environment account of a first virtual environment. In some implementations, operation 402 may be performed by an user account module the same as or similar to user account module 24 (shown in FIG. 1 and described above).

At an operation 403, the first user is authenticated to the first virtual environment through the first virtual environment account, wherein the first virtual environment account is identified by the first account identifier that is included in the account identifiers of the first user account. In some implementations, operation 403 may be performed by an user access module the same as or similar to user access module 22 (shown in FIG. 1 and described above).

At an operation 404, a second user account is managed, wherein the second user account includes account identifiers corresponding to user accounts associated with virtual environments. The account identifiers include a second account identifier for a second virtual environment account of a second virtual environment. The second virtual environment may be different from the first virtual environment. In some implementations, operation 404 may be performed by a user account module the same as or similar to user account module 24 (shown in FIG. 1 and described above).

At an operation 406, a determination is made that the first user may be participating in the first virtual environment through the first virtual account. In some implementations, operation 406 may be performed by a user account module the same as or similar to user account module 24 (shown in FIG. 1 and described above).

At an operation 408, a determination is made that the second user may be participating in the second virtual environment through the second virtual account. In some implementations, operation 408 may be performed by a user account module the same as or similar to user account module 24 (shown in FIG. 1 and described above).

At an operation 410, status information regarding participation of the second user in the second virtual environment is generated. In some implementations, operation 410 may be performed by a interface module the same as or similar to interface module 28 (shown in FIG. 1 and described above).

At an operation 412, a user interaction interface is generated for presentation to the first user, responsive to the determination regarding the second user, wherein the user interaction interface may facilitate interaction between the first user and the second user. The user interaction interface may also present the generated status information. In some implementations, operation 412 may be performed by an interface module the same as or similar to interface module 28 (shown in FIG. 1 and described above).

At an operation 414, communications are transmitted to virtual environments causing presentation of the user interaction interface to the first user. In some implementations, operation 414 may be performed by a launch module the same as or similar to launch module 30 (shown in FIG. 1 and described above).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to facilitate user interaction between multiple virtual environments, the system comprising:
one or more processors configured to execute computer program modules, the computer program modules comprising:
a user account module configured to manage user accounts that include account information of users, wherein the account information of the users includes a plurality of account identifiers corresponding to a plurality of virtual environment accounts organized on a per-user basis within the user account module, and wherein the user accounts comprise:
a first user account that corresponds to a first user, the first user account including a first set of virtual environment account identifiers for a plurality of virtual environment accounts in different virtual environments, the first set of virtual environment account identifiers including a first account identifier for a first virtual environment account in a first virtual environment; and
a second user account that corresponds to a second user, the second user account including a second set of virtual environment account identifiers for a plurality of virtual environment accounts in different virtual environments, the second set of virtual environment account identifiers including a second account identifier for a second virtual environment account in a second virtual environment that is different from the first virtual environment; and
an interface module configured to generate, responsive to the first user participating in the first virtual environment through the first virtual environment account, and responsive to the second user participating in the second virtual environment through the second virtual environment account, a first user interaction interface for presentation to the first user, wherein the first user interaction interface is configured to facilitate real time or near real time interaction between the first user and the second user, and wherein the first user interaction interface is further configured to present status information regarding participation of the second user in the second virtual environment.

2. The system of claim 1, further comprising a relationship module configured to establish mutual relationships between users of virtual environments, wherein the relationship module has established a mutual relationship between the first user and the second user.

3. The system of claim 2, wherein the relationship module is configured such that establishment of mutual relationships between users of virtual environments is further configured based on an analysis of relationships of the first user with other users in the first virtual environment.

4. The system of claim 1, wherein account information of the first user includes access authorization information of the first virtual environment account, and wherein generation by the interface module is pursuant to authorization through the access authorization information.

5. The system of claim 1, wherein status information regarding participation of the second user in the second virtual environment includes an indication whether the second user is currently participating in the second virtual environment.

6. The system of claim 1, wherein the interface module is configured such that generation of the first user interaction interface is further responsive to the first user initiating participation in the first virtual environment by authorizing transmission of communications to a virtual environment server and/or a client computing platform external to the system, wherein the communications cause presentation of views from an instance of the first virtual environment to the first user.

7. The system of claim 1, wherein the first user interaction interface is configured such that facilitation of real time or near real time interaction includes one or more of instant messaging, chat, text messaging, multi-media messaging, video-over-IP calling, or voice-over-IP calling.

8. The system of claim 1, wherein status information regarding the second user includes an indication whether the second user is currently available for real time or near real time interaction facilitated through the first user interaction interface.

9. The system of claim 1, wherein account information includes access authorization information, and wherein generation of the first user interaction interface is pursuant to authorization through the access authorization information.

10. The system of claim 1, wherein the first account identifier for the first virtual environment is included in the account information of the first user account.

11. The system of claim 1, wherein the launch module is configured to present the first user interaction interface to the first user via a client computing platform external to the system.

12. The system of claim 1, further comprising a launch module configured to transmit communications to virtual environment servers and/or client computing platforms external to the system, wherein the communications cause:
presentation of the first user interaction interface to the first user; and
presentation of a first user environment interface to the first user, wherein the first user environment interface includes views from an instance of the first virtual environment.

13. The system of claim 12, wherein the presentation of the first user interaction interface by the launch module is performed using a window separate from the presentation of the first user environment interface, such that the window including the first user interaction interface lacks presentation of native navigation controls for manual navigation of a network.

14. The system of claim 12, wherein the presentation of the first user interaction interface is performed in combination with the presentation of the first user environment interface, such that a window including the combination includes presentation of native navigation controls for manual navigation of a network.

15. The system of claim 14, wherein the window including the combination is configured such that the first user interaction interface has an appearance as a toolbar in the first user environment interface.

16. A method to facilitate user interaction between multiple virtual environments, the method comprising:
managing user accounts that include account information of users, wherein the account information of the users includes a plurality of account identifiers corresponding to a plurality of virtual environment accounts organized on a per-user basis, and wherein the user accounts comprise:
a first user account that corresponds to a first user, the first user account including a first set of virtual environment account identifiers for a plurality of virtual environment accounts in different virtual environments, the first set of virtual environment account identifiers including a first account identifier for a first virtual environment account in a first virtual environment; and
a second user account that corresponds to a second user, the second user account including a second set of virtual environment account identifiers for a plurality of virtual environment accounts in different virtual environments, the second set of virtual environment account identifiers including a second account identifier for a second virtual environment account in a second virtual environment that is different from the first virtual environment;
determining that the first user is participating in the first virtual environment through the first virtual environment account;
determining that the second user is participating in the second virtual environment through the second virtual environment account;
generating status information regarding participation of the second user in the second virtual environment;
generating, responsive to both determinations, a first user interaction interface for presentation to the first user, wherein the first user interaction interface is configured to facilitate real time or near real time interaction between the first user and the second user, and wherein the first user interaction interface is further configured to present the status information; and
transmitting first communications to one or more virtual environment servers and/or client computing platforms, wherein the first communications cause presentation of the first user interaction interface to the first user.

17. The method of claim 16, further comprising:
transmitting second communications to one or more virtual environment servers and/or client computing platforms, wherein the communications cause presentation of a first user environment interface to the first user, wherein the first user environment interface includes views from an instance of the first virtual environment.

18. The method of claim 17, wherein the presentation of the first user interaction interface is performed using a window separate from the presentation of the first user environment interface, such that the window including the first user interaction interface lacks presentation of native navigation controls for manual navigation of a network.

19. The method of claim 17, wherein the presentation of the first user interaction interface is performed in combination with the presentation of the first user virtual environment interface, such that a window including the combination includes presentation of native navigation controls for manual navigation of a network.

20. The method of claim 19, wherein the window including the combination is configured such that the first user interaction interface has an appearance as a toolbar in the window containing the combination.

21. The method of claim 16, further comprising:
establishing a mutual relationship between the first user and the second user.

22. The method of claim 21, wherein establishing a mutual relationship between the first user and the second user is based on an analysis of relationships of the first user with other users in the first virtual environment.

23. The method of claim 16, wherein account information of the first user includes access authorization information of the first virtual environment account, and wherein generating the first user interaction interface is pursuant to authorization through the access authorization information.

24. The method of claim 16, wherein the status information includes an indication whether the second user is currently participating in the second virtual environment.
